(19) United States
(12) Patent Application Publication
(10) Pub. No.: US 2012/0218774 A1
(43) Pub. Date: Aug. 30, 2012

(54) Led light bulb

(76) Inventor: Troy W. Livingston, Northbrook, IL (US)

(21) Appl. No.: 13/385,478

(22) Filed: Feb. 22, 2012

Related U.S. Application Data
(60) Provisional application No. 61/464,127, filed on Feb. 28, 2011.

(51) Int. Cl. F21V 13/02; F21V 29/00

(52) U.S. Cl. 362/555; 362/249.02

(57) ABSTRACT

The LED bulb includes a body in the shape of a standard domestic light bulb and has a base which can be screwed into a standard AC receptacle. The bulb comprises a plurality of cooling fins made of aluminum and cast to form the outer surface of the light bulb. A central opening extends axially through the bulb with the interior edges of the cooling fins forming the interior periphery of the opening. The bulb thus provides two cooling air flow paths. A heat sink for supporting a circuit board carrying the LEDs is cast together with the fins. The bulb may be connected in any orientation and still retain its same cooling characteristics. A lens faceted circular surface also having a central opening disperses the photons in an overlapping manner to provide a uniform alighted area even though the bulb has a central opening.

This application claims the benefit of the earlier filing date of the provisional application LED LIGHT BULB of the same inventor, Troy W. Livingston, Ser. No. 61/464,127, filed on Feb. 28, 2011.

### BACKGROUND OF THE INVENTION

Light emitting diodes (LEDs) are semiconductor diodes that belong to a group of known as electro luminescent luminaries. LEDs constitute desirable sources of lighting because they operate at low voltage and power, are small and have an extended lifetime. LED bulbs may also be a direct replacement for standard domestic incandescent lights since the base of the LED bulbs is compatible with standard AC sockets. However, the LEDS generate a tremendous amount of heat that must be dissipated in order for the LEDs to continue to operate without burning out. To dissipate the heat most manufacturers have incorporated an aluminum body with fins to increase the area to dissipate the heat. For instance, some LEDs have currents of up to 700 mA running through them. While this is a small amount compared to a standard light bulb, it is applied to a tiny piece of material, no larger than 5/16″ in diameter. Thus the current of 700 mA is huge for this size material and hence a lot of heat is thus generated. from the current. As is obvious, the higher the operating current the higher the heat load that must be dissipated. Thus numerous and long fins are generally required for LED bulbs.

### SUMMARY OF THE INVENTION

One embodiment of the inventive LED bulb shown includes a body in the shape of a standard domestic AC incandescent light bulb and having a base which can be screwed into a standard domestic light bulb AC receptacle. Bulb includes an array of LEDs providing photons through respective light pipes to a lens system. The bulb comprises a plurality of cooling fins generally labeled which fins are of aluminum cast in a shape to form the outer surface of the light bulb. The bulb includes a central opening extending axially through the bulb with the interior edges of the cooling fins form the interior periphery of opening. Thus the bulb provides cooling airflow path around the exterior surface of the bulb and another second airflow path to the fins via the central opening. A heat sink for supporting a circuit board carrying the LEDs is cast together with the fins. The heat sink is swedged to the circuit board to carrying the LEDS assure a proper transfer of heat from the board to the heat sink. The heat sink is constructed to evenly distribute the heat generated by the LEDs to the fins whereby the bulb may be connected in any orientation, that is vertically, upside down or horizontally and still retain its same cooling characteristics. A faceted lens circular surface also having a central opening disperses the photons in an overlapping manner to provide a uniform lighted area even though the bulb has the central opening.

The foregoing features and advantages of the present invention will be apparent from the following more particular description of the invention. The accompanying drawings, listed herein below, are useful in explaining the invention.

### DRAWINGS

FIG. 1 is an isometric view to show the shape or configuration of the inventive bulb, to show the central hollow core of the inventive Led bulb and the exterior and interior cooling fins;

FIG. 2 is an isometric view, partially is section, to show various components of the inventive Led bulb;

FIG. 3 is a side view of the Led bulb of FIG. 1 to show the solid core heat sink and the mounting of the Led printed circuit board on the heat sink;

FIG. 4 depicts a light guide or pipe provided to direct and reflect the photons upwards toward the faceted lens face;

FIG. 5 is sketch of the lens facets face;

FIG. 6 is a relatively enlarged view of FIG. 5 to show the dispersion and overlap of the output photons from the inventive bulb;

FIG. 7 depicts the conductive path of the heat sink and airflow path that cools the LEDs when the bulb is mounted in a vertical position;

FIG. 8 depicts the airflow path that cools the bulb when the bulb is mounted in a relatively upside down position;

FIG. 9 depicts an airflow path that cools the LEDs when the bulb is mounted on its side;

FIG. 10 depicts generally the same concept as FIG. 7, and depicts the cooling airflow paths through the entire bulb;

FIG. 11 depicts generally the same concept as FIG. 8, and depicts the cooling airflow paths through the entire bulb; and

FIG. 12 depicts generally the same concept as FIG. 9, and depicts the cooling airflow paths through the entire bulb.

### DESCRIPTION OF THE INVENTION

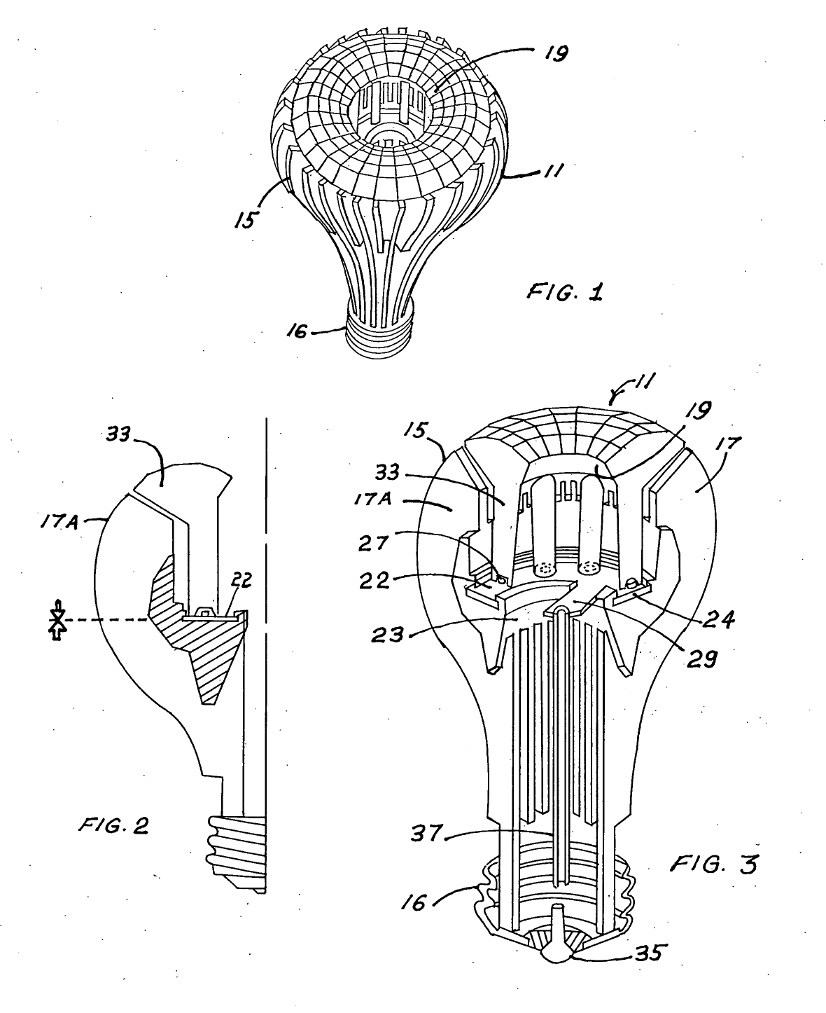

FIGS. 1 and 2 show the structural shape of one embodiment of the inventive Led bulb 11 comprising an array of LEDs 27. The number of LEDs may vary and in one embodiment nine LEDs are positioned in bulb 11. As shown in FIGS. 1 and 2 bulb 11 has a body 15 in the shape of a standard domestic incandescent bulb and has a base 16 which can be screwed into a standard domestic light bulb AC receptacle. Bulb 11 comprises a plurality of cooling fins generally labeled 17 which fins are of aluminum cast in a shape such that their outer edges form the exterior surface of the bulb. The lower end of fins 17 is mechanically and electrically connected to the base 16. The bulb 11 includes a central opening 19 extending axially through the bulb 11. The interior edge of cooling fins 17 form the periphery of opening 19.

FIG. 2, which is partially in section, depicts various components of the bulb 11, as will be explained. Refer now also to FIG. 3. The multiple fins 17 for forming the body 15 of bulb 11 are cast in a conventional mold. The parting line 21 for the casting is indicated in FIG. 3. Each of the cooling fins 17 actually comprise and outer cooling fin section 17A and an inner cooling fin segment 17B, as clearly seen in FIG. 2. In addition, a solid core heat sink 22 of aluminum is cast with the fins. The heat sink 22 has a central opening 23 (see FIG. 3) and is circular in shape and includes a flat surface 24 on which a printed circuit board 25 carrying the LEDs 27 is mounted.

Refer now specifically to FIG. 2, a plate 29 extend across the central opening of heat sink 22. A center tube 37 for securing an electrical lead, not shown, extends along the axis of the bulb 11 and has its upper end affixed to plate 21. A center electrical contact pin 35 is insulatively affixed to the base 16.

Refer now also to FIG. 4. A light pipe or light guide 33 is mounted around each of the LEDs 27. In other embodiments, a light pipe may be positioned around two or more LEDs 27. As is known, photons from the LEDs 27 are directed and reflected up the light pipe toward faceted lens 36, as depicted by line 41 in FIG. 4. As indicated in FIG. 5 the outer surface of lens 36 is faceted, as is known in the art, to effect a dispersion of the photons. FIG. 6 depicts the dispersion of the output photons by lines labeled generally as 49 from the lens facets surfaces 36A and 36B. Because of the dispersion of the photons, a uniform lighted area is provided from the LED bulb 11 even though the bulb has a central opening 23.

Refer again FIG. 3 and also to FIG. 6. In order to obtain a good heat interface of the LED printed circuit board 25 and the heat sink 22 to thereby provide a good heat flow path for dissipating the heat generated by the LEDs 27 the heat sink has been carefully constructed to provide balanced heat dissipation characteristics. Further to assure a tight contact between the surface of the heat sink 22 and the circuit board 25, the sides 38 and 39 of the heat sink 22 are swedged (bent over to firmly grip the edges) to the circuit board 25, FIG. 4

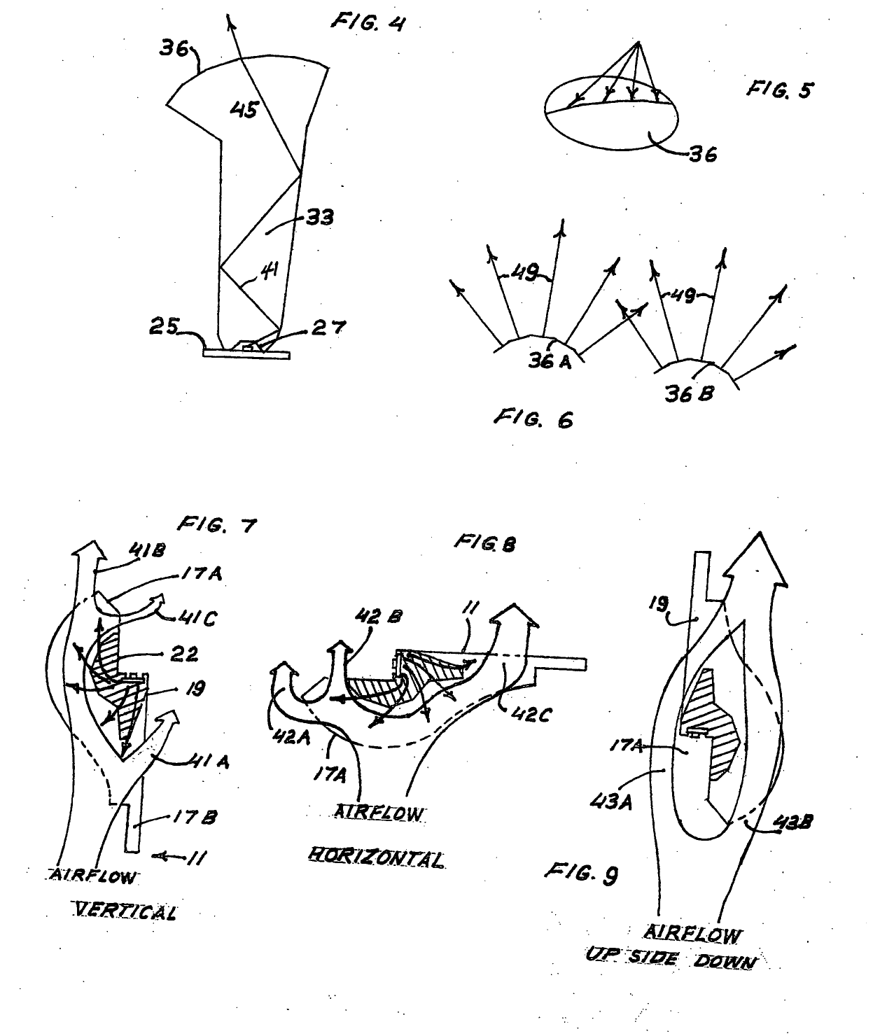

As shown in FIGS. 7, 8 and 9 the heat flow paths indicated by the arrow lines 44 extend outwardly from the heat source comprising the LEDs 27 and the printed circuit board 25 in a rather uniform pattern through the heat sink 22 to its periphery and to the associated fins 17. The foregoing construction provides an important feature for bulb 11 in that it can be mounted for operation in any orientation and still provide adequate cooling to the LEDs. FIGS. 7, 8 and 9 depicts the air flow path for cooling the fins 17, the heat sink 22, circuit board 25 and LEDs 27 when the bulb 11 is mounted in various orientations, as indicted in the drawings. FIG. 7 depicts the bulb mounted vertically. The heat sink conducts heat from the LED 27 uniformly to the cooling fin 17 comprising sections 17A and 17 B. A portion of the airflow path labeled 41A flows up through the central axial opening 23 thus cooling fin section 17B. A portion of the air flow path labeled 41B also goes up around and adjacent fin section 17A to provide cooling thereto. Further, a portion of the airflow path labeled 41C flows around the upper tip of fin 17A and toward the central opening 19 and out the top of bulb 11.

FIG. 8 shows the airflow path when the bulb 11 is mounted in a horizontal orientation. The airflow path labeled 42A moves upwardly around the top of bulb 11 to provide cooling to the exterior fin section 17A. The airflow path labeled 42B flows through the interior fin section 17B. A portion of the air flow path labeled 42B flows through the top of fin 17 an through the central opening 19 and out the top of bulb 11.

FIG. 9 shows the airflow path when the bulb 11 is mounted in a vertical up side down orientation. The airflow path labeled 43A moves around the exterior fin section 17A to provide cooling thereto. The airflow path labeled 43 moves up through the central opening 19 to provide cooling to the interior fin section 17B. In the all the various orientation of the bulb 11 indicted a maximum airflow is provided to the LEDs to effect adequate cooling.

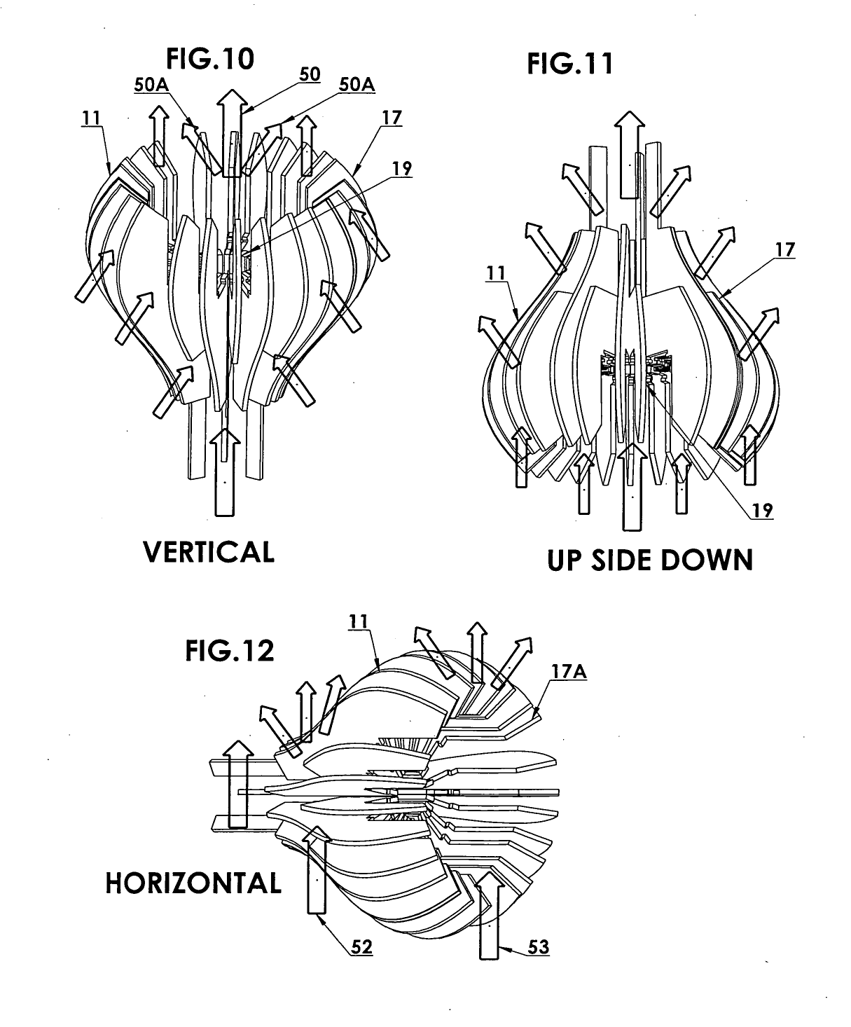

FIG. 10 depicts the airflow paths for the overall bulb when the bulb 11 is mounted in a vertical orientation similarly to FIG. 7, is somewhat easier to

Because of the better cooling characteristic, of the inventive bulb, higher output energy can be developed by the LEDs without destroying (burning up) the LEDs, and thus a high output wattage an be obtained from the inventive bulb 11.

While the invention has been particularly shown and described with reference to preferred embodiments thereof, it will be understood by those skilled in the art that various changes in form and details may be made therein without departing from the spirit and scope of the invention.

1. A housing within a bulbous upper body section tapering down to a tubular section that is affixed to the base for mounting to a standard AC socket;
b) cooling fins shaped to have an inner edge and an outer edge such that a plurality of the fins join together form the external sections of said housing,
c) inner edges of said fins being joined together for forming a central axial opening;
d) a circuit board;
e) an array of spaced LEDs mounted on said circuit board;
f) a solid core heat sink, said heat sink being positioned to provide a mounting surface for said circuit board; and
g) said fins providing multiple paths for airflow around said fans through said central openings to effect cooling of said LEDs.

2. An LED light source as in claim one wherein
said heat sink is constructed to have a uniform conducting pattern from said circuit board to said LEDs through said fans regardless of the mounting orientation of said bulb.

3. An LED light source as in claim one wherein
a) said fins are cast as a single unit;

4. An LED light source as in claim 1 including
a) a faceted lens system mounted on said housing; an
b) light pipes provided for each of said LEDs for directing photons from said LEDs to said lens system.

5. An LED light source comprising;
a) a housing in the shape of a standard domestic incandescent light bulb with a bulbous upper body section tapering down to a tubular section that is affixed to a base for mounting to a standard AC socket;
b) cooling fins shaped to have an inner edge and an outer edge such that a plurality of the fins join together form the external sections of said housing, said fins being cast as a unit;
c) inner edges of said fins when joined together forming a central axial opening
d) a circuit board;
e) an array of spaced LEDs mounted on said circuit board;
f) a faceted lens system mounted on said housing;
g) light pipes for each of said LEDs for directing photons from said LEDs to said lens system;
h) a solid core heat sink cast being together with said fins;
i) said heat sink being positioned to provide a mounting surface for said circuit board; and
j) said fins providing multiple paths for airflow around said fans through said central openings to effect cooling of said LEDs.

6. An LED light source as in claim 1 wherein
a) a multifaceted prism is affixed to the uppermost portion of the housing to provide a wide angle distribution of light from said housing.
